(19) United States
(12) Patent Application Publication
(10) Pub. No.: US 2025/0350084 A1
(43) Pub. Date: Nov. 13, 2025

(54) DEVICE AND METHOD FOR MULTI-WAVELENGTH LASER DRIVING AND SYSTEM AND METHOD FOR MULTI-WAVELENGTH LASER PROCESSING

(71) Applicant: INDUSTRIAL TECHNOLOGY RESEARCH INSTITUTE, Hsinchu (TW)

(72) Inventors: Jia-You WANG, Kaohsiung City (TW); Fu-Shun HO, Tainan City (TW); Kuo-Teng TSAI, Penghu County (TW); Chih Chun CHEN, Kaohsiung City (TW); Yu-Cheng SONG, Tainan City (TW)

(73) Assignee: INDUSTRIAL TECHNOLOGY RESEARCH INSTITUTE, Hsinchu (TW)

(21) Appl. No.: 18/808,335

(22) Filed: Aug. 19, 2024

(30) Foreign Application Priority Data
May 8, 2024 (TW) 113116974

(51) Int. Cl. H01S 3/091; B23K 26/064; B23K 26/354; H01S 3/08; H01S 3/13; H01S 3/23

(52) U.S. Cl. CPC H01S 3/0912; B23K 26/064; B23K 26/354; H01S 3/08086; H01S 3/1305; H01S 3/2391

(57) ABSTRACT

A multi-wavelength laser driving device includes a controller, a first light source driver, a feedback circuit and a second laser source light source driver. The controller is configured to generate a first driving signal according to setting data, and the setting data includes a first driving period of the first laser source. A first light source driver is connected to the controller and configured to drive the first laser source according to the first driving signal. The feedback circuit is configured to obtain a first feedback signal in response to the first driving signal from the first laser source and generate a second driving signal according to the first feedback signal. The second light source driver is connected to the feedback circuit and the controller, and is configured to drive the second laser source according to the first driving period and the second driving signal.

### CROSS-REFERENCE TO RELATED APPLICATIONS

This non-provisional application claims priority under 35 U.S.C. § 119(a) on Patent Application No(s). 113116974 filed in Republic of China (ROC) on May, 8, 2024, the entire contents of which are hereby incorporated by reference.

### BACKGROUND

### 1. Technical Field

This disclosure relates to a device and method for multi-wavelength laser driving and system and method for multi-wavelength laser processing.

### 2. Related Art

With the rapid development of electric vehicles and energy storage industries, the demand for welding of certain materials (e.g. copper, aluminum and other metals) has also increased. In particular, certain materials (e.g. metal) have poor absorptivity for traditional lasers. In order to cope with the requirement of increasing material thickness, it may be necessary to significantly increase the laser power to more than 10 kilowatts for processing.

### SUMMARY

According to one or more embodiment of this disclosure, a device for multi-wavelength laser driving, applicable to a first laser source and a second laser source having different laser wavelength ranges, includes a controller, a first light source driver, a second light source driver and a feedback circuit. The controller is configured to generate a first driving signal according to setting data, wherein the setting data includes a first driving period related to the first laser source. The first light source driver is connected to the controller and configured to drive the first laser source according to the first driving signal. The feedback circuit is configured to obtain a first feedback signal in response to the first driving signal from the first laser source and generate a second driving signal according to the first feedback signal. The second light source driver is connected to the feedback circuit and the controller, and configured to drive the second laser source according to the first driving period and the second driving signal.

According to one or more embodiment of this disclosure, a method for multi-wavelength laser driving, applicable to a first laser source and a second laser source having different laser wavelength ranges, includes: generating, by a controller, a first driving signal according to setting data, wherein the setting data includes a first driving period related to the first laser source; driving, by a first light source driver, the first laser source according to the first driving signal; by a feedback circuit, obtaining a first feedback signal in response to the first driving signal from the first laser source and generating a second driving signal according to the first feedback signal; and driving, by a second light source driver, the second laser source according to the first driving period and the second driving signal.

According to one or more embodiment of this disclosure, a system for multi-wavelength laser processing, applicable to surface processing for a material to be processed, includes the device for multi-wavelength laser driving, the first laser source and the second laser source described above. The first laser source is configured to be driven by the device for multi-wavelength laser driving according to the first driving signal so as to perform a first heat treatment to the material to be processed. The second laser source is configured to be driven by the device for multi-wavelength laser driving according to the second driving signal so as to perform a second heat treatment to the material to be processed.

According to one or more embodiment of this disclosure, a method for multi-wavelength laser processing, applicable to surface processing for a material to be processed, includes generating, by a controller, a first driving signal according to setting data, wherein the setting data includes a first driving period related to the first laser source; driving, by a first light source driver, a first laser source to emit light according to the first driving signal to perform a first heat treatment to the material to be processed; by a feedback circuit, obtaining a first feedback signal in response to the first driving signal from the first laser source and generating a second driving signal according to the first feedback signal; and driving, by a second light source driver, a second laser source to emit light according to the first driving period and a second driving signal to perform a second heat treatment to the material to be processed.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a block diagram of a multi-wavelength laser processing system based on a multi-wavelength laser driving device according to an embodiment of the present disclosure;

FIG. 2 is a schematic diagram of a first laser source and a second laser source coupled with each other in a multi-wavelength laser processing system according to an embodiment of the present disclosure;

FIG. 3 is a schematic cross-sectional view of an optical fiber bundle shown in FIG. 2;

FIG. 4 is a flow chart of a multi-wavelength laser driving method according to an embodiment of the present disclosure;

FIG. 5 is a schematic diagram of a signal for switching a multi-wavelength laser according to an embodiment of the present disclosure;

FIG. 6 is a block diagram of a multi-wavelength laser processing system based on a multi-wavelength laser driving device according to another embodiment of the present disclosure;

FIG. 7 is a flow chart of a multi-wavelength laser driving method according to another embodiment of the present disclosure;

FIG. 8 is a block diagram of a multi-wavelength laser processing system according to still another embodiment of the present disclosure; and

FIG. 9 is a flow chart of a multi-wavelength laser driving method according to still another embodiment of the present disclosure.

### DETAILED DESCRIPTION

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

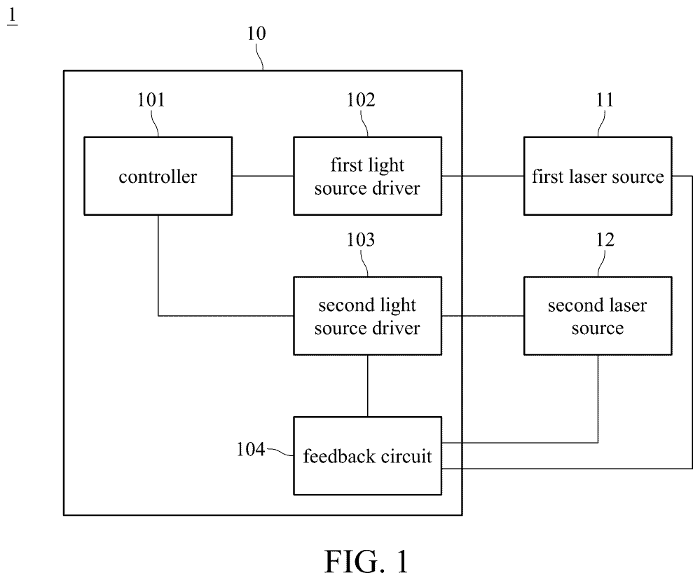

Please refer to FIG. 1 which is a block diagram of a multi-wavelength laser processing system based on a multi-wavelength laser driving device according to an embodiment of the present disclosure. As shown in FIG. 1, a multi-wavelength laser processing system 1 may be applicable to surface processing for a material to be processed. The multi-wavelength laser processing system 1 includes a multi-wavelength laser driving device 10, a first laser source 11 and a second laser source 12, wherein the first laser source 11 and the second laser source 12 have different laser wavelength ranges. The multi-wavelength laser driving device 10 includes a controller 101, a first light source driver 102, a second light source driver 103 and a feedback circuit 104. The controller 101 is configured to generate a first driving signal according to setting data, wherein the setting data includes a first driving period related to the first laser source. The first light source driver 102 is connected to the controller 101 and configured to drive the first laser source 11 according to the first driving signal. The feedback circuit 104 is configured to obtain a first feedback signal in response to the first driving signal from the first laser source 11 and generate a second driving signal according to the first feedback signal. The second light source driver 103 is connected to the feedback circuit 104 and the controller 101, and configured to drive the second laser source 12 according to the first driving period and the second driving signal. The first laser source 11 is configured to be driven by the multi-wavelength laser driving device 10 according to the first driving signal, to heat the material to be processed for the first time. The second laser source 12 is configured to be driven by the multi-wavelength laser driving device 10 according to the second driving signal, to heat the material to be processed for the second time.

In the embodiment, the controller 101 may include one or more processing/control units with data receiving, recording, computing, storage and output functions. The processing/control unit is, for example, a microcontroller, a central processing unit, a graphics processor, a programmable logic controller, or any combination of the above. The controller 101 may generate the first driving signal according to the setting data to drive the first laser source 11 through the first light source driver 102. The setting data may include the first driving period related to the output time of the first laser source 11. Specifically, the setting data may further include at least one of setting output power and setting pulse width of the first laser source 11, and at least one of setting output power and setting pulse width of the second laser source 12. Through the above parameters, the controller 101 may control the output power, pulse width, repetition rate, etc. of the first laser source 11 and the second laser source 12. It should be noted that in practice, the controller 101 may be configured to adjust any adjustable parameters of the laser source, and is not limited to the above examples.

The first laser source 11 and the second laser source 12 may be laser diodes with different laser wavelength ranges respectively, but the laser sources in the present disclosure are not limited to being implemented by laser diodes. The wavelength selection of the first laser source 11 and the second laser source 12 may be determined based on the absorptivity of the materials to be processed for light of different wavelengths at different temperatures. Specifically, the light of the first laser source may have a first wavelength and the first laser source may be configured to heat the material to be processed from a room temperature to the first temperature, the light of the second laser source may have a second wavelength and the second laser source may be configured to heat the material to be processed from the first temperature to a second temperature. At the first temperature, the material to be processed has absorptivity for the light of the first wavelength higher than absorptivity for the light of the second wavelength, and at the second temperature, the material to be processed has absorptivity for the light of the second wavelength higher than absorptivity for the light of the first wavelength.

For example, when the material to be processed is a metal material such as copper or aluminum, considering that copper and aluminum have poor absorptivity for infrared light with longer wavelengths at a room temperature, and have better absorptivity for infrared light with longer wavelengths at high temperatures, the wavelength of the first laser source 11 may be selected in the range of blue light (e.g., 450 nm) or green light (e.g., 532 nm), and the wavelength of the second laser source 12 may be selected in the range of infrared light (e.g., 1064 nm). That is, the first wavelength of the first laser source 11 is selected to be shorter than the second wavelength of the second laser source 12. Also, for other types of materials to be processed, the appropriate first and second wavelengths of the laser may be determined based on their absorptivity spectrum, to achieve the effect of switching bands for segmented processing and improve laser processing efficiency.

In addition, the output power of the first laser source 11 and the output power of the second laser source 12 may be different. Specifically, the output power of the second laser source 12 may be greater than the output power of the first laser source 11. Taking the first laser source 11 having the wavelength range of blue light and the second laser source 12 having the wavelength range of infrared light as an example, the first laser source 11 of blue wavelength is suitable for preheating the material to be processed (e.g., copper, aluminum) with lower power, and the second laser source 12 of infrared wavelength is suitable for heating the material to be processed with higher power and higher temperature. In this way, although the output power of the second laser source 12 is higher, compared with the infrared laser, the blue laser has lower conversion efficiency and consumes higher energy. Therefore, by first using blue laser with lower power for preheating and then using infrared laser with higher power for secondary heating, the power consumption of the overall laser processing may be effectively reduced. In particular, the first laser source 11 used for preheating may be a Quasi Continuous Wave (QCW) laser, which may produce an output with instantaneous peak of higher power to quickly preheat the material.

The first light source driver 102 and the second light source driver 103 may be, for example, laser drivers corresponding to the laser sources. The first light source driver 102 and the second light source driver 103 may each have a computing unit. The first light source driver 102 may drive the first laser source 11 for the first driving period when receiving the first driving signal. The second light source driver 103 may drive the second laser source 12 after the first driving period when receiving the second driving signal, to achieve the effect of automatically switching the first laser source 11 and the second laser source 12. In addition, the first light source driver 102, the second light source driver 103, a pulse generator and a signal processing unit (such as a digital-to-analog converter) may be combined into a multi-wavelength light source driver to respectively drive and control the first laser source 11 and the second laser source 12. The feedback circuit 104 is configured to obtain the first feedback signal in response to the first driving signal from the first laser source 11, and generate the second driving signal according to the first feedback signal to drive the second laser source 12. That is, the feedback circuit 104 may drive the second laser source 12 through the second light source driver when receiving the feedback signal from the first laser source 11, thereby achieving the effect of laser processing of switching wavelengths.

Further, the feedback circuit 104 may be selectively connected to the second laser source 12 for obtaining a second feedback signal from the second laser source 12 and stopping outputting the second driving signal according to the second feedback signal. Specifically, the feedback circuit 104 may output the second driving signal when receiving the first driving signal, and stop outputting the second driving signal when receiving the second feedback signal.

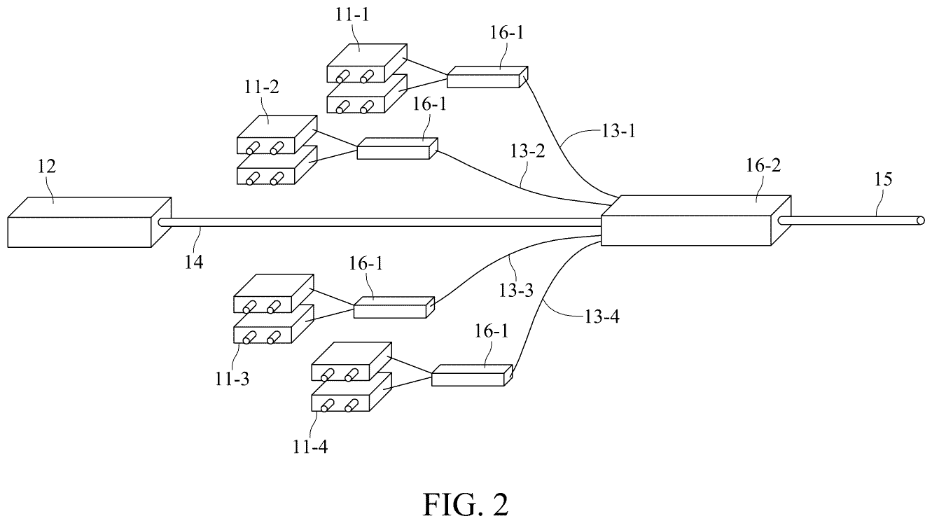

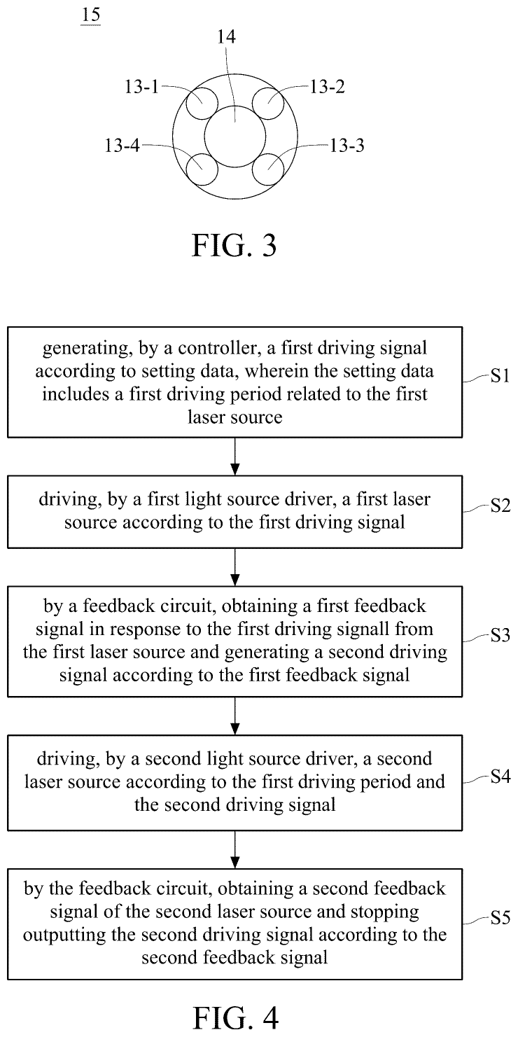

The first laser source 11 and the second laser source 12 in the multi-wavelength laser processing system described in each embodiment of the present disclosure may be coupled to each other to form a hybrid light source with a single output end. Please refer to FIG. 2 and FIG. 3, FIG. 2 is a schematic diagram of a coupled first laser source and a second laser source in a multi-wavelength laser processing system according to an embodiment of the present disclosure, FIG. 3 is a schematic cross-sectional view of an optical fiber bundle shown in FIG. 2. As shown in FIG. 2, in the present embodiment, the multi-wavelength laser processing system may include four sets of first laser sources 11-1, 11-2, 11-3 and 11-4, and a set of second laser source 12, wherein four sets of first laser sources 11-1, 11-2, 11-3 and 11-4 are respectively coupled into four secondary optical fibers 13-1, 13-2, 13-3 and 13-4 through multiple optical fiber couplers 16-1 to output blue laser, and the second laser source 12 outputs infrared laser through the primary optical fiber 14. The laser parameters of each set of blue-light lasers include a wavelength of 450 nm and an output power of 200 watts, and the laser parameters of the infrared laser include a wavelength of 1064 nm and an output power of 4000 to 6000 watts. The four sets of secondary optical fibers 13-1, 13-2, 13-3 and 13-4 and the primary optical fiber 14 are coupled into an optical fiber bundle 15 through an optical fiber coupler 16-2. As shown in FIG. 3, the primary optical fiber 14 may be disposed at the center of the optical fiber bundle 15, and the secondary optical fibers 13-1, 13-2, 13-3 and 13-4 may be disposed at the side positions of the optical fiber bundle 15, thus forming a mixed light source with single output.

Please refer to FIG. 4 along with FIGS. 1-3, FIG. 4 is a flow chart of a multi-wavelength laser driving method according to an embodiment of the present disclosure. As shown in FIG. 4, the multi-wavelength laser driving method may include step S1: generating, by a controller, a first driving signal according to setting data, wherein the setting data includes a first driving period related to the first laser source; step S2: driving, by a first light source driver, a first laser source according to the first driving signal; step S3: by a feedback circuit, obtaining a first feedback signal in response to the first driving signal from the first laser source and generating a second driving signal according to the first feedback signal; step S4: driving, by a second light source driver, a second laser source according to the first driving period and the second driving signal; and step S5: by the feedback circuit, obtaining a second feedback signal of the second laser source and stopping outputting the second driving signal according to the second feedback signal.

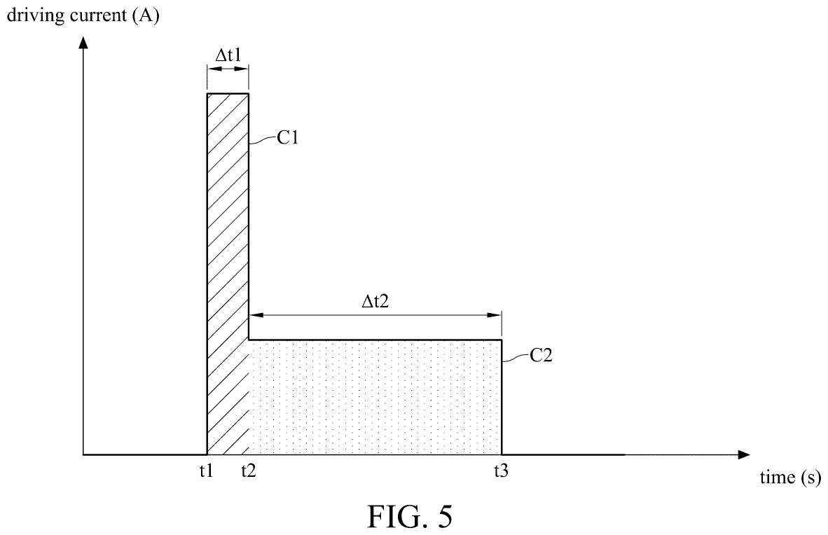

In steps S1 and S2, the controller 101 may generate the first driving signal according to the setting data including the first driving period related to the first laser source 11, so that the first light source driver 102 drives the first laser source 11 according to the first driving signal. Please refer to FIG. 5 along with FIG. 4, FIG. 5 is a schematic diagram of a signal for switching a multi-wavelength laser according to an embodiment of the present disclosure. As shown in FIG. 5, in steps S1 and S2, the controller 101 may generate a first driving signal C1 with an instantaneous high current according to the setting data at time point t1, wherein the duration (i.e. pulse width) of the first driving signal C1 corresponds to the first driving period At1, so that the first light source driver 102 drives the first laser source 11 according to the first driving signal C1 and continues for the first driving period At1.

In step S3, when the feedback circuit 104 obtains the first feedback signal in response to the first driving signal C1 from the first laser source 11, the second driving signal C2 may be generated according to the first feedback signal. In step S4, the second light source driver 103 may wait for the set first driving period At1 when receiving the second driving signal, and drive the second laser source 12 after the first driving period At1 of receiving the second driving signal. In step S5, the feedback circuit 104 may delay the second feedback signal according to the second driving period At2 when receiving the second feedback signal from the second laser source 12, and stop outputting the second driving signal C2 according to the second feedback signal at time point t3 after the second driving period At2. The information of the second driving period At2 may be preset in the feedback circuit 104 or provided to the feedback circuit 104 by the controller 101. In this way, by respectively adjusting the first driving period At1 and the second driving period At2, the processing time of laser light sources with different wavelengths may be controlled. It should be noted that step S5 is an optional step. That is, the feedback circuit 104 of the multi-wavelength laser processing system 1 may not perform step S5 of stopping outputting the second driving signal according to the second feedback signal. Alternatively, after step S4 of driving the second laser source 12 by the second light source driver 103, the second light source driver 103 may stop driving the second laser source 12 at a time point according to the second driving period At2 in the setting data of the controller 101.

In addition, the present disclosure further proposes a multi-wavelength laser processing method based on the multi-wavelength laser driving method described above. Specifically, the multi-wavelength laser processing method may include the steps S1 to S5. In step S2, the first light source driver 102 may drive the first laser source 11 to emit light according to the first driving signal C1 to heat the material to be processed for the first time. In step S4, the second light source driver may drive the second laser source 12 to emit light according to the first driving period At1 and the second driving signal C2 to heat the material to be processed for the second time.

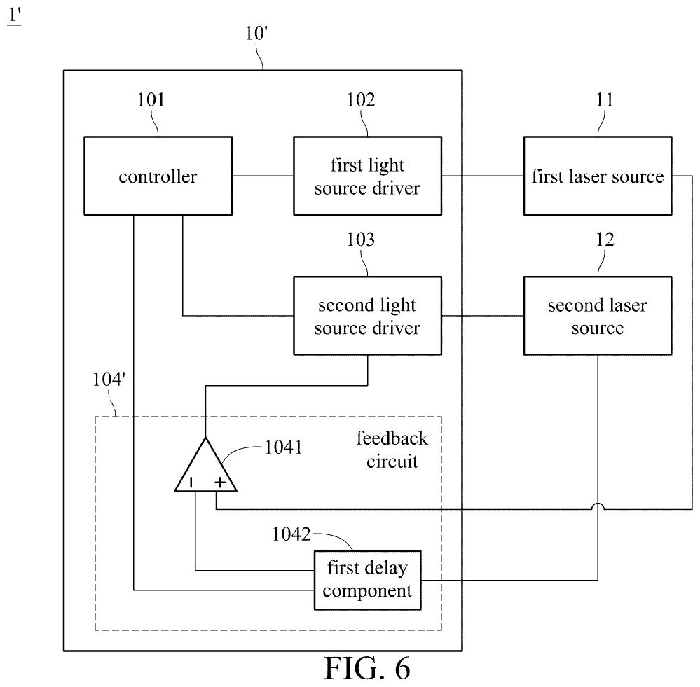

Please refer to FIG. 6, FIG. 6 is a block diagram of a multi-wavelength laser processing system based on a multi-wavelength laser driving device according to another embodiment of the present disclosure. Compared with FIG. 1, the multi-wavelength laser processing system 1′ of FIG. 6 is basically the same as the multi-wavelength laser processing system 1 of FIG. 1, except that the feedback circuit 104′ of the multi-wavelength laser driving device 10′ in the present embodiment includes a comparator 1041 and a first delay component 1042. The first delay component 1042 is configured to obtain a second feedback signal in response to the second driving signal from the second laser source 12, and delay the second feedback signal. Specifically, in one implementation, the first delay component 1042 may not be connected to the controller 101 and delay the second feedback signal according to a preset second driving period. Alternatively, the first delay component 1042 may also receive setting data including the second driving period from the controller 101, and delay the second feedback signal according to the second driving period. The comparator 1041 has a first input terminal (+) for obtaining the first feedback signal, a second input terminal (−) connected to the first delay element 1042 for obtaining the delayed second feedback signal, and an output end connected to the second light source driver 103. The comparator 1041 outputs the second driving signal through the output terminal when determining that the electric potential of the first input terminal (+) is higher than the electric potential of the second input terminal (−); and the comparator stops outputting the second driving signal when determining that the electric potential of the first input terminal (+) is not higher than the electric potential of the second input terminal (−). Through the configuration of the feedback circuit 104′ in the present embodiment, the multi-wavelength laser processing system 1′ may determine whether the two lasers have been switched reaching the second driving period by comparing the first feedback signal and the second feedback signal, and stop outputting the second driving signal to turn off the second laser source 12 when the second driving period is reached.

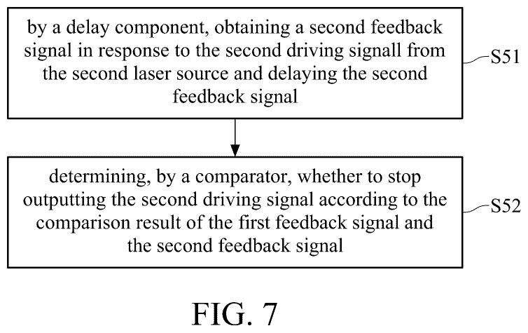

Please refer to FIG. 7 along with FIG. 6, FIG. 7 is a flow chart of a multi-wavelength laser driving method according to another embodiment of the present disclosure. As shown in FIG. 7, step S5 may include step S51: by a delay component, obtaining a second feedback signal in response to the second driving signal from the second laser source 12 and delaying the second feedback signal; and step S52: determining, by a comparator, whether to stop outputting the second driving signal according to the comparison result of the first feedback signal and the second feedback signal. Specifically, when the second feedback signal is delayed and has not reached the second driving period, the comparator may determine that the electric potential of an input terminal receiving the first feedback signal is higher than the other input terminal receiving the second feedback signal, and thereby does not stop outputting the second driving signal. When the second feedback signal is delayed and has reached the second driving period, the comparator may determine that the electric potential of the input terminal receiving the first feedback signal is not higher than the other input terminal receiving the second feedback signal, and thereby stops outputting the second driving signal. In addition, the laser driving method in this embodiment may also be used for multi-wavelength laser processing. Specifically, the comparator may stop outputting the second driving signal (step S52) to end the second heating of the material to be processed by the second laser source when determining that the electric potential of the input terminal that receives the first feedback signal is not higher than the electric potential of the input terminal that receives the second feedback signal.

It should be noted that in addition to using the comparator 1041 and the first delay component 1042 to implement the feedback circuit 104′ with the functions described above, the feedback circuit may also have other implementations. Specifically, the feedback circuit may include a computing component. The first input terminal of the computing component is configured to obtain the first feedback signal of the first laser source 11, and the second input terminal of the computing component is configured to obtain the second feedback signal of the second laser source 12. The computing component may output the second driving signal when determining that the electric potential of the first input terminal is higher than the electric potential of the second input terminal. The computing component may stop outputting the second driving signal when determining that the electric potential of the first input terminal is not higher than the electric potential of the second input terminal. In this way, the computing component may stop outputting the second driving signal according to the first feedback signal and the second feedback signal. For example, the computing component may be an operational amplifier, but this is not limited in the present disclosure.

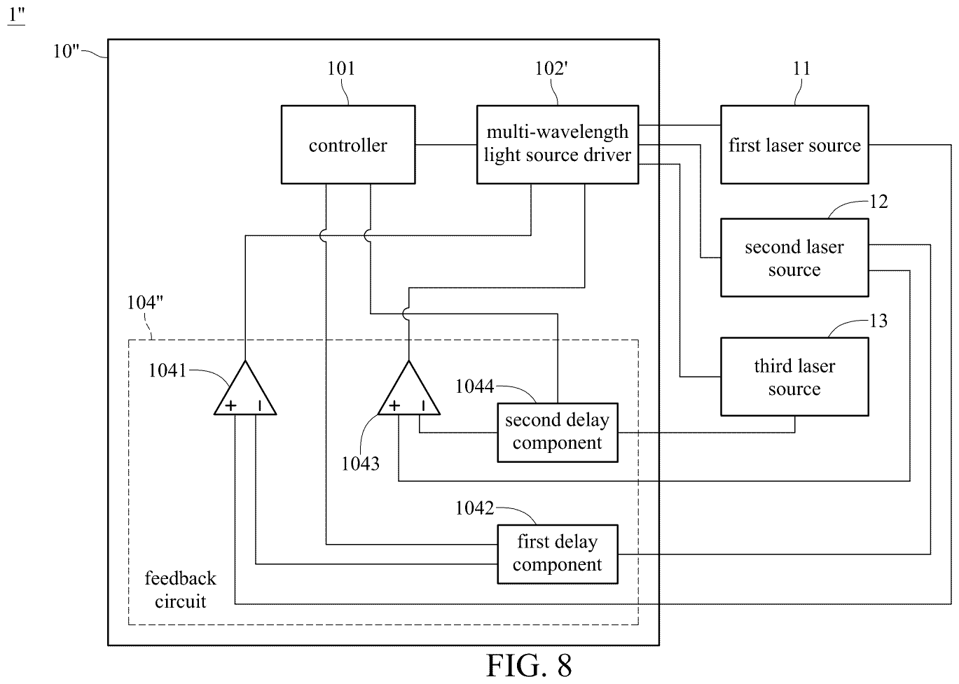

As described above, the present disclosure has proposed one or more laser driving devices and processing systems with dual-wavelength switching mechanisms. On this basis, it can be expanded to a laser driving device and processing system with multi-wavelength switching mechanisms based on the same concept. Please refer to FIG. 8, FIG. 8 is a block diagram of a multi-wavelength laser processing system according to still another embodiment of the present disclosure. As shown in FIG. 8, compared with FIG. 1 and FIG. 6, the multi-wavelength laser processing system 1″ of this embodiment further includes a third laser source 13, wherein the third laser source 13 has a different laser wavelength range from the first laser source 11 and the second laser source 12. In this embodiment, the setting data of the controller 101 of the multi-wavelength laser driving device 10″ may further include a second driving period. The feedback circuit 104″ may be further configured to obtain a second feedback signal from the second laser source 12 and generate a third driving signal according to the second feedback signal. The third light source driver is connected to the feedback circuit 104″ and the controller 101, and is configured to drive the third laser source 13 according to the second driving period and the third driving signal. Similar to the first light source driver of the previous embodiment, the third light source driver may have a computing unit, so that the third light source driver may drive the third laser source 13 after the second driving period when receiving the third driving signal. It should be noted that the first to third light source drivers in this embodiment are integrated into a multi-wavelength light source driver 102′.

In this example, the feedback circuit 104″ may include two sets of comparators and delay components similar to the embodiment of FIG. 2 to achieve the effect of switching the first to third laser 11 to 13. Specifically, the first input terminal (+) of the first comparator 1041 may be connected to the first laser source 11 to receive the first feedback signal, and the second input terminal (−) of the first comparator 1041 may be connected to the second laser source 12 through the first delay component 1042 to receive the second feedback signal with the second delay time. The first input terminal (+) of the second comparator 1043 may be connected to the second laser source 12 to receive the second feedback signal, and the second input terminal (−) of the second comparator 1043 may be connected to the third laser source 13 through the second delay component 1044 to receive the third feedback signal with the third delay time. It should be noted that the first delay component 1042 in this embodiment may be connected to the controller 101 to receive setting information with the second delay time, or the second delay time may be preset in the first delay component 1042; and the second delay component 1044 in this embodiment may be connected to the controller 101 to receive setting information with the third delay time, or the third delay time may be preset in the second delay component 1044.

Through the configuration of FIG. 8, when the first laser source 11 is driven, the first comparator 1041 may generate a second driving signal according to the first feedback signal of the first laser source 11 to drive the second laser source 12. When the second laser source 12 is driven, the first comparator 1041 may receive the delayed second feedback signal after the second driving period and stop outputting the second driving signal according to the first and second feedback signals. At the same time, the second comparator 1043 may generate a third driving signal according to the second feedback signal of the second laser source 12 to drive the third laser source 13. When the third laser source 13 is driven, the second comparator 1043 may receive the delayed third feedback signal after the third driving period and stop outputting the third driving signal according to the second and third feedback signals. In this way, a laser driving system and method with three-stage switching may be realized. Similar configuration may also serve to achieve the laser driving system and method with more stages of switching, which is not described in detail herein. In addition, the feedback circuit 104″ in this embodiment does not have to be implemented by comparators and delay components. In other implementations, it may also be implemented by computing components as in the foregoing embodiments, and repeated descriptions are omitted herein.

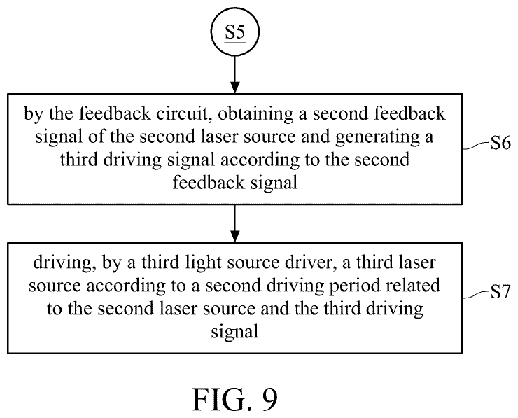

Please refer to FIG. 9 along with FIG. 4 and FIG. 8, FIG. 9 is a flow chart of a multi-wavelength laser driving method according to still another embodiment of the present disclosure. As shown in FIG. 9, the multi-wavelength laser driving method and multi-wavelength laser processing method in this embodiment may, after step S5, further include step S6: by the feedback circuit, obtaining a second feedback signal of the second laser source and generating a third driving signal according to the second feedback signal; and step S7: driving, by a third light source driver, a third laser source according to a second driving period related to the second laser source and the third driving signal. The laser driving method in this embodiment may also be used for multi-wavelength laser processing. Specifically, the third light source driver may drive the third laser source 13 according to the second driving period and the third driving signal related to the third laser source 13 (step S7), to heat the material to be processed for the third time.

In view of the above description, by using the feedback circuit to obtain the feedback signal of the first laser source through the feedback circuit and generate the driving signal of the second laser source based on the feedback signal, and by using the second light source driver to drive the second laser source after receiving the driving period of the driving signal according to the driving period provided by the controller, the device and method for multi-wavelength laser driving of the present disclosure may achieve freely switching multi-wavelength lasers. Based on this multi-wavelength laser driving device and method, the system and method for multi-wavelength laser processing of the present disclosure may first drive the first laser source to preheat the material to be processed, and then switch to drive the second laser source to heat the material to be processed for the second time. In this way, laser light sources of different wavelengths may be freely switched during manufacturing or processing process. According to the different absorptivity of the material to be processed for different wavelengths of light at different temperatures, the overall efficiency of the laser processing process may be improved and the power consumption may be reduced. In addition, by using a delay component to delay the second feedback signal according to a second driving period, the comparator may stop outputting the second feedback signal after the second driving period according to the comparison result of the first and second feedback signals, to automatically switch the second laser source to the off state, thereby simplifying the control process.

It will be apparent to those skilled in the art that various modifications and variations can be made to the disclosed embodiments. It is intended that the specification and examples be considered as exemplars only, with a true scope of the disclosure being indicated by the following claims and their equivalents.

What is claimed is:

1. A device for multi-wavelength laser driving, applicable to a first laser source and a second laser source having different laser wavelength ranges, comprising:
a controller configured to generate a first driving signal according to setting data, wherein the setting data comprises a first driving period related to the first laser source;
a first light source driver connected to the controller, and configured to drive the first laser source according to the first driving signal;
a feedback circuit configured to obtain a first feedback signal in response to the first driving signal from the first laser source, and configured to generate a second driving signal according to the first feedback signal; and
a second light source driver connected to the feedback circuit and the controller, and configured to drive the second laser source according to the first driving period and the second driving signal.

2. The device for multi-wavelength laser driving of claim 1, wherein the feedback circuit is further configured to obtain a second feedback signal of the second laser source, and stop outputting the second driving signal according to the second feedback signal.

3. The device for multi-wavelength laser driving of claim 1, wherein the feedback circuit comprises:
a delay component configured to obtain a second feedback signal in response to the second driving signal from the second laser source, and delay the second feedback signal; and
a comparator having a first input terminal for obtaining the first feedback signal, a second input terminal connected to the delay component for obtaining the delayed second feedback signal, and an output terminal connected to the second light source driver,
wherein the comparator outputs the second driving signal through the output terminal when determining that electric potential of the first input terminal is higher than electric potential of the second input terminal, and stops outputting the second driving signal when determining that the electric potential of the first input terminal is not higher than the electric potential of the second input terminal.

4. The device for multi-wavelength laser driving of claim 3, wherein the setting data further comprises a second driving period related to the second laser source, and the delay component is connected to the controller and further configured to delay the second feedback signal according to the second driving period.

5. The device for multi-wavelength laser driving of claim 1, further applicable to a third laser having a different laser wavelength range from the first laser source and the second laser source, wherein:
the setting data of the controller further comprises a second driving period related to the second laser source,
the feedback circuit is further configured to obtain a second feedback signal in response to the second driving signal from the second laser source, and generate a third driving signal at least according to the second feedback signal, and
the device for multi-wavelength laser driving further comprises:
a third light source driver connected to the feedback circuit and the controller, and configured to drive the third laser according to the second driving period and the third driving signal.

6. A system for multi-wavelength laser processing, applicable to surface processing for a material to be processed, comprising:
the device for multi-wavelength laser driving of claim 1;
the first laser source configured to be driven by the device for multi-wavelength laser driving according to the first driving signal so as to heat the material to be processed for a first time; and
the second laser source configured to be driven by the device for multi-wavelength laser driving according to the second driving signal so as to heat the material to be processed for a second time.

7. The system for multi-wavelength laser processing of claim 6, wherein:
the first laser source outputs light of a first wavelength and is configured to heat the material to be processed from a room temperature to a first temperature,
the second laser source outputs light of a second wavelength and is configured to heat the material to be processed from the first temperature to a second temperature,
wherein at the first temperature, the material to be processed has absorptivity for the light of the first wavelength higher than absorptivity for the light of the second wavelength, and
at the second temperature, the material to be processed has absorptivity for the light of the second wavelength higher than absorptivity for the light of the first wavelength.

8. The system for multi-wavelength laser processing of claim 7, wherein the first wavelength is shorter than the second wavelength.

9. The system for multi-wavelength laser processing of claim 6, wherein an output power of the second laser source is greater than an output power of the first laser source.

10. The system for multi-wavelength laser processing of claim 6, wherein the first laser source comprises a first optical fiber, the second laser source comprises a plurality of second optical fibers, and the first optical fiber and the plurality of second optical fibers are combined into an optical fiber bundle.

11. A method for multi-wavelength laser driving, applicable to a first laser source and a second laser source having different laser wavelength ranges, comprising:
generating, by a controller, a first driving signal according to setting data, wherein the setting data comprises a first driving period related to the first laser source;
driving, by a first light source driver, the first laser source according to the first driving signal;
by a feedback circuit, obtaining a first feedback signal in response to the first driving signal from the first laser source and generating a second driving signal according to the first feedback signal; and
driving, by a second light source driver, the second laser source according to the first driving period and the second driving signal.

12. The method for multi-wavelength laser driving of claim 11, further comprising:
by the feedback circuit, obtaining a second feedback signal of the second laser source and stopping outputting the second driving signal according to the second feedback signal.

13. The method for multi-wavelength laser driving of claim 11, further comprising:
by a delay component, obtaining a second feedback signal in response to the second driving signal from the second laser source and delaying the second feedback signal;
by a comparator, obtaining the first feedback signal through a first input terminal and obtaining the delayed second feedback signal through a second input terminal;
outputting, by the comparator, the second driving signal through an output terminal when determining that electric potential of the first input terminal is higher than electric potential of the second input terminal; and
stopping outputting, by the comparator, the second driving signal when determining that the electric potential of the first input terminal is not higher than the electric potential of the second input terminal.

14. The method for multi-wavelength laser driving of claim 13, wherein the setting data further comprises a second driving period related to the second laser source, and
delaying, by the delay component, the second feedback signal comprises:
delaying the second feedback signal according to a second driving period of the setting data.

15. The method for multi-wavelength laser driving of claim 11, further applicable to a third laser having a different laser wavelength range from the first laser source and the second laser source, and further comprising:
by the feedback circuit, obtaining a second feedback signal in response to the second driving signal from the second laser source, and generating a third driving signal at least according to the second feedback signal; and
driving, by a third light source driver, the third laser according to the second driving period related to the second laser source and the third driving signal.

16. A method for multi-wavelength laser processing, applicable to surface processing for a material to be processed, comprising:
generating, by a controller, a first driving signal according to setting data, wherein the setting data comprises a first driving period related to a first laser source;
driving, by a first light source driver, the first laser source to emit light according to the first driving signal to heat the material to be processed for a first time;
by a feedback circuit, obtaining a first feedback signal in response to the first driving signal from the first laser source and generating a second driving signal according to the first feedback signal; and
driving, by a second light source driver, a second laser source to emit light according to the first driving period and a second driving signal to heat the material to be processed for a second time.

17. The method multi-wavelength laser processing of claim 16, further comprising:
selecting the first laser source having a first wavelength and the second laser source having a second wavelength according to absorptivity of the material to be processed for light of different wavelengths at different temperatures,
wherein heating the material to be processed for the first time comprises heating the material to be processed from a room temperature to a first temperature,
heating the material to be processed for the second time comprises heating the material to be processed from the first temperature to a second temperature,
at the first temperature, the material to be processed has absorptivity for the light of the first wavelength higher than absorptivity for the light of the second wavelength, and
at the second temperature, the material to be processed has absorptivity for the light of the second wavelength higher than absorptivity for the light of the first wavelength.

18. The method multi-wavelength laser processing of claim 17, wherein the first wavelength is shorter than the second wavelength.

19. The method multi-wavelength laser processing of claim 16, wherein an output power of the second laser source is greater than an output power of the first laser source.

20. The method multi-wavelength laser processing of claim 16, wherein heating the material to be processed for the first time comprises:
heating the material to be processed for the first time through a first optical fiber of an optical fiber bundle, and
heating the material to be processed for the second time comprises:
heating the material to be processed for the first time through a plurality of second optical fibers of the optical fiber bundle.
